(19) United States
(12) Patent Application Publication
(10) Pub. No.: US 2024/0232129 A1
(43) Pub. Date: Jul. 11, 2024

(54) Programmable Compute Architecture

(71) Applicant: RapidSilicon US, Inc, Los Gatos, CA (US)

(72) Inventors: Pierre-Emmanuel Gaillardon, Salt Lake City, UT (US); Robert Liston, Los Gatos, CA (US)

(73) Assignee: RapidSilicon US, Inc, Los Gatos, CA (US)

(21) Appl. No.: 18/297,296

(22) Filed: Apr. 7, 2023

Related U.S. Application Data
(60) Provisional application No. 63/479,304, filed on Jan. 10, 2023.

(51) Int. Cl. G06F 15/78; G06F 9/30

(52) U.S. Cl. CPC G06F 15/7882; G06F 9/30058; G06F 9/30065

(57) ABSTRACT

A technology is described for a programmable compute architecture with clusters of floating point units (FPUs), a random-access-memory (RAM), and a plurality of configurable logic blocks (CLBs) defining a data plane and a limited instruction set central processing unit (CPU) communicating in the cluster with the FPUs, the RAM, and the CLBs as a control plane. The CPU can control branching and/or looping the FPUs and the CLBs.

### PRIORITY CLAIM

Priority is claimed to U.S. Provisional Patent Application No. 63/479,304, filed Jan. 10, 2023, which is hereby incorporated herein by reference.

### BACKGROUND

General purpose field programmable gate array (FPGA) platforms may be used in signal processing applications due to their ability to create very versatile digital platforms and capability to achieve high compute capabilities. Despite the broad use of FPGAs in the field, they may not be fully optimized for the compute density used in wideband processing and machine learning algorithms.

### BRIEF DESCRIPTION OF THE DRAWINGS

FIG. 1 is a diagram illustrating an example of the programmable compute architecture with streaming clusters.

FIG. 2 is a diagram illustrating an example of the programmable compute architecture interfaced to a radio frequency (RF) front end using high speed serial transceivers.

FIG. 3 is a diagram illustrating an example of a programmable compute cluster of the programmable compute architecture.

FIG. 4 is a diagram illustrating an example of a high-level micro-architecture concept of the cluster with a hard-macro central processing unit (CPU) with direct hooks to other blocks in the cluster to customize the cluster.

FIG. 5 is a diagram illustrating an example streaming dot-product operation implemented in a cluster.

FIG. 6 is a diagram illustrating an example of a programmable routing fabric with clusters.

### DETAILED DESCRIPTION

Reference will now be made to the examples illustrated in the drawings, and specific language will be used herein to describe the same. It will nevertheless be understood that no limitation of the scope of the technology is thereby intended. Alterations and further modifications of the features illustrated herein, and additional applications of the examples as illustrated herein, which would occur to one skilled in the relevant art and having possession of this disclosure, are to be considered within the scope of the description.

As stated earlier, general purpose field programmable gate array (FPGA) platforms may not be fully optimized for the compute density desired for wideband processing, machine learning algorithms and other similar computing applications. The present technology or architecture can be a domain-specific FPGA fabric with reconfigurable clusters tailored to support various classes of workloads. In order to achieve the desired compute, input/output (I/O), and re-configurability specifications, the present architecture can be a domain-specific, fine-grained reconfigurable architecture useful for data-stream-heavy workloads, such as spectrum sensing, software-defined radio tasks, machine learning, sensor fusion, etc.

There can be tradeoffs and dilemmas between FPGAs and central processing units (CPUs) used in real-time edge intelligence. Real-time edge intelligence addresses how to process data from sensors, such as laser imaging, detection, ranging (e.g. light detection and ranging or LiDAR), cameras, radio frequency (RF) modems, spectrum sensing, automotive, wireless communication, etc., where a massive amount of data enters a system for signal processing and decision making and such processing that cannot just be sent to the cloud. One option is to utilize a regular FPGA for processing streaming signal processes in parallel, which can handle higher throughput, but an FPGA has limited program switching capabilities. Another option is to use a CPU that provides run time decision capabilities for complex program switching but lower throughput. For example a CPU based system may only process a subset of the data while discarding the remaining data.

Some architectures can be compared based on compute density and program switch time. A FPGA provides more compute density but lower program switch time. The CPU allows more program switch time but has lower compute density. The present architecture with reconfigurable clusters allows for a compute density greater than 200 GOPS/mm² and a program switch time less than 50 ns, in one example aspect.

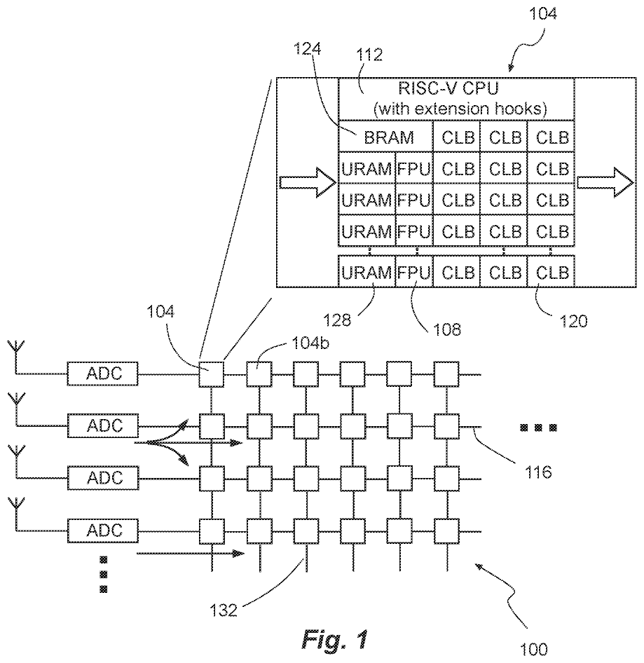

FIG. 1 illustrates an example programmable compute architecture 100 with streaming clusters 104 that receive streaming data to be processed. The streaming clusters 104 may be floating point unit (FPU) 108 rich to enable more calculations. The streaming clusters 104 also have an embedded limited instruction set central processing unit (CPU) 112 for a control plane and programming switching capabilities. The streaming clusters 104 can be programmed for various different operations or applications which process data. In addition, multiple streaming clusters 104 can be coupled together in a data stream or pipeline 116 with data flowing from one cluster 104 to another cluster 104b for processing. Thus, a data stream or pipeline 116 can have multiple streaming clusters 104 coupled together. Furthermore, multiple clusters 104 can be configured to each process a separate data stream and form a pipeline 116. Multiple streams of data 116 can be processed by the architecture 100. In addition, the architecture 100 can be flexible as described herein.

In one aspect, each cluster 104 can be FPU 108 rich for greater compute density. In another aspect, the cluster 104 can have more FPUs 108 and digital signal processors (DSPs), and less configurable logic blocks (CLBs) 120 and look up tables (LUTs), than a typical FPGA tile. The embedded limited instruction set CPU 112 can provide control and improve program switch time. The clusters 104 can also have block random-access-memory (BRAM) 124 and unified random-access-memory (URAM) 128. The clusters 104 can be arrayed in a fabric 132 with interconnects and input/output (I/O) blocks, as discussed in greater detail herein. The interconnects and input/output (I/O) blocks may be connected between the clusters 104 to form the pipelines already discussed.

In one aspect, the CPU 112 can be a simplified or limited instruction set CPU. In one example, the limited instruction set CPU 112 may not include a complex instruction set but may be able to use an extended instruction set (ISA) that can be programmed into the CLBs 120 and used by the CPU 112. In another aspect, the limited instruction set CPU 112 can be a fifth generation reduced instruction set computer (RISC-V) CPU.

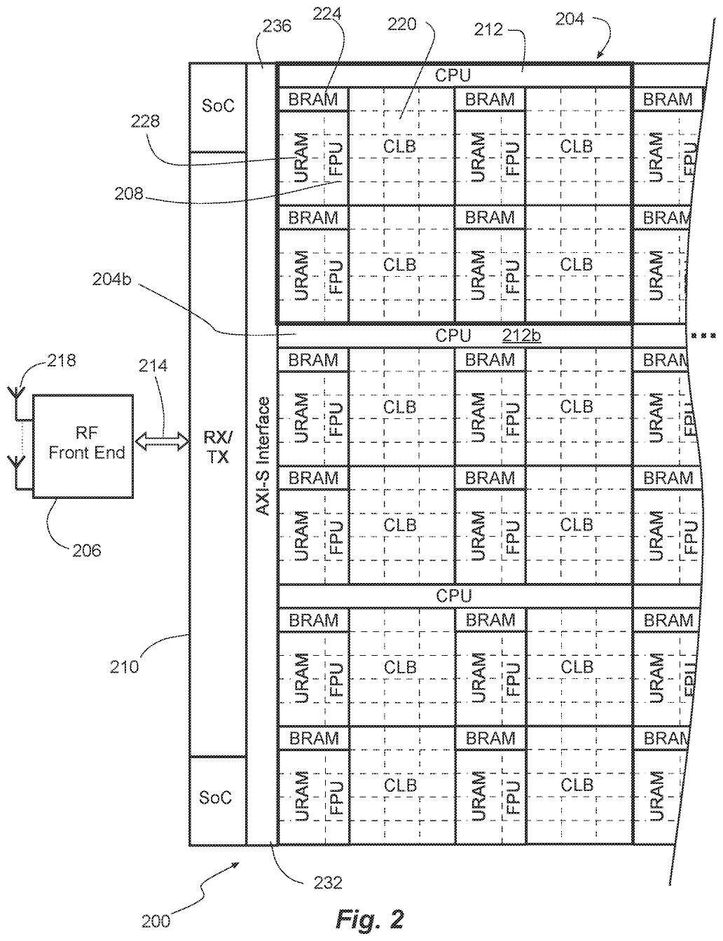

FIG. 2 illustrates an island-style programmable compute architecture 200 with a set of clusters 204 capable of both achieving a high-degree of mission reconfigurability alongside a high-performance data path(s). In one example of the architecture, the architecture 200 may interface to a radio frequency (RF) front end 206 using high speed serial transceivers 210. The input/output (I/O) configuration 214 can use 30 lanes at 28 Gb/s and 14b I/Q resolution to support up to 30 GHz full duplex baseband bandwidth. The I/Q samples (quadrature signals) can be channelized to support multiple antennas 218 for multiple-input multiple-output (MIMO) signal localization and beamforming. Additional signals can be received by the RF front end 206 for low latency automatic gain control (AGC) and power amplifier (PA) control.

The real time I/Q sample stream can be injected into the fabric 232 of the architecture 200 using standard AXI-S streaming interfaces 236, running in parallel at 800 MHZ. The core fabric 232 can process the I/Q sample stream in real time and can support a variety of workloads including traditional digital signal processing (DSP) algorithms, such as fast Fourier transform (FFT), complex matrix multiplication, and cross correlation. Other workloads can be processed including deep model evaluations, such as parameter estimation and classification tasks. The architecture 200 can be optimized for massively parallel implementations of flowgraph processes using fine grain computation and the clusters 204. Thus, a first cluster 204 with a first CPU 212 (in the darker box) can be configured to perform a first operation while a second cluster 204b with a second CPU 212b can be configured to perform a different second operation.

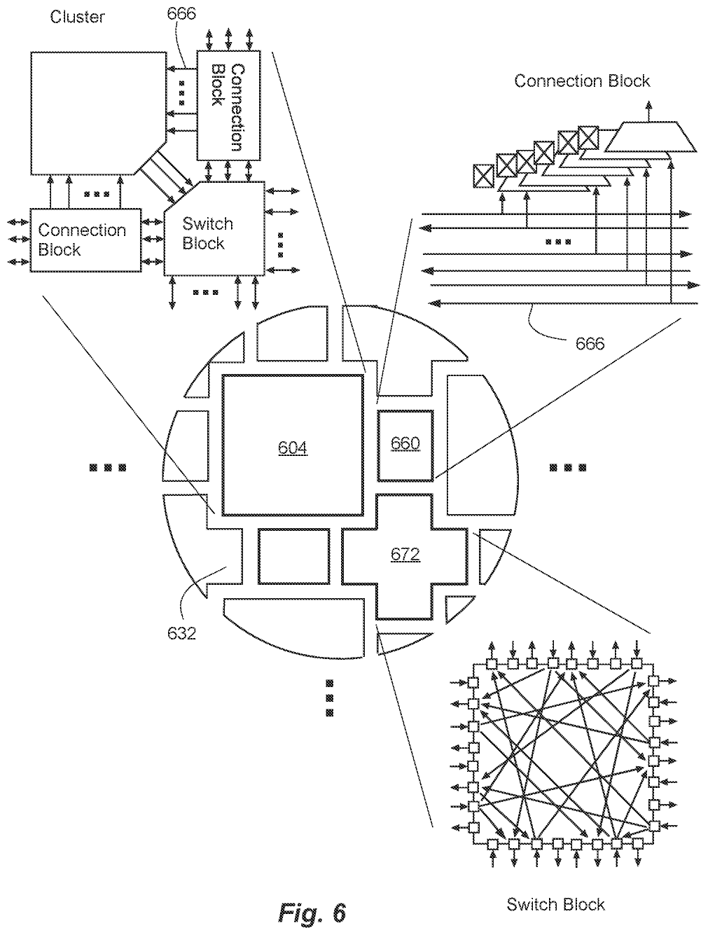

The clusters 204 of the architecture 200 are further composed of configurable logic blocks (CLB) 220 along with vectorized FPUs 208 and memory blocks (BRAM 224 and URAM 228), connected using a programmable routing fabric 232. These clusters 204 enable parallelization of the implementation of RF sensing algorithms, for example using deep pipelining and customized data paths. The core building block or cluster 204 comprises data path tiles (e.g. FPUs 208 and CLBs 220) along with a customized RISC-V CPU 212. The tiles are connected using a programmable routing fabric 232 (as shown in FIG. 6). The data path tiles may include random-access-memory (RAM), such as BRAM 224 (true dual port RAM) and URAM 228 (high density single port RAM), FPUs 208 (vectorized, multi-precision floating point and integer arithmetic operations), and CLBs 220 (configurable logic for nonlinear operations and data multiplexing). In a typical flowgraph or machine learning application, the BRAM 224 is responsible for streaming buffer storage and the URAM 228 contains model parameters, enabling very high throughput and low latency. In conjunction with the data path tiles, an optimized RISC-V CPU 212 can be provided as a flexible control unit.

The example compute density of the architecture 200 can be estimated using 16 nm fin field-effect transistor (FinFET) technology. Synthesis of the basic computation cluster 204, i.e. the streamlined FPU 208, may achieve a density of <1000 um² per FP16 (floating point 16) operation, and an assumed use at 25% density in the architecture fabric 232. Running at 800 MHZ, this may result in raw compute density slightly above 200 GFLOP/s per 1 mm². The expected compute units are typically four times greater than a general-purpose FPGA generally offers.

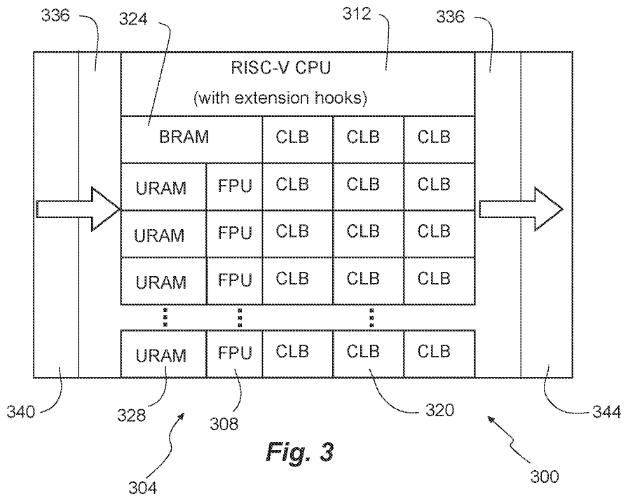

FIG. 3 illustrates a cluster 304 of the programmable compute architectures described herein. The cluster 304 can have a plurality of floating point units (FPUs) 308. A random-access-memory (RAM) can be communicatively coupled to the FPUs 308. The RAM can include block random-access-memory (BRAM) 324 communicatively coupled to the FPUs 308 and configured to act as input buffer storage to the FPU 308. The RAM can also comprise unified random-access-memory (URAM) 328 communicatively coupled to the FPUs 308 that is configured to store parameters used by the FPUs 308. A plurality of configurable logic blocks (CLBs) 320 can be communicatively coupled to the RAM, such as the BRAM 324, and the FPUs 308.

A limited instruction set central processing unit (CPU) 312 can be located in the cluster 304 with, and communicatively coupled to: the FPUs 308, the RAM 324 and 328, and the CLBs 320. The limited instruction set CPU 312 can be formed on and embedded on an integrated circuit (IC) with the FPUs 308, the RAM 324 and 328, and the CLBs 320.

The limited instruction set CPU 312 can be capable of configuring the FPUs 308 and the CLBs 320 to control looping and/or branching for program segments executed by the FPUs 308 and the CLBs 320. The CPU 312 can be configured to manage program control structure (iteration control/looping, selection logic (e.g., branching) and sequence logic) and perform program control. In one aspect, the cluster 304 can be configured to be dynamically reconfigured based on information extracted from an input signal by using the RAM, e.g. the BRAM 324 as configuration instruction storage.

A local bus 336 can be located in the cluster 304 and communicatively coupled to the FPUs 308, the BRAM 324, the URAM 328, the CLBs 320 and the limited instruction set CPU 312. In one aspect, the FPUs 308, the RAM 324 and 328, and the CLBs 320 can define a data plane. The limited instruction set CPU 312 can define a control plane. The limited instruction set CPU 312 can have a direct data connection to the data plane via the local bus 336 in the cluster 304 to configure the FPUs 308 and the CLBs 320. Thus, the limited instruction set CPU 312 in the cluster 304 with the FPUs 308, the BRAM 324, the URAM 328 and the CLBs 320 may communicate using the local bus 336. In another aspect, the local bus 336 can form interconnects to route signals to and from the limited instruction set CPU 312, the FPUs 308, the RAM 324 and 328, and the CLBs 320.

In one aspect, the bus 336 can be or can comprise a hard macro routing interface, including an input router 340 and an output router 344. The input router 340 can route data to the cluster 304 and the output router 344 can route data from the cluster 308 to other clusters (such as 204b in FIGS. 2 and 104b in FIG. 1). The router 340 and 344 can be a parallel bus. In one aspect, the routing interface or routers 340 and 344 can be an advanced extensible interface stream (AXI-S). The routers 340 and 344 can be configured to allow data to enter the cluster 312 or reroute the data to another cluster, such as a subsequent cluster in the data stream or pipeline. The processing of the cluster 304 can have a fixed configuration and the CPU 312 can control branching and/or looping. In one aspect, an AXI-S bus can be utilized with preconfigured routes. In another aspect, an advanced extensible interface (AXI) bus can be utilized based on an address assigned to each cluster. In yet another aspect, a network on chip (NoC) architecture can be utilized and communications may be based on a packet address that refers to a cluster address.

The cluster 304 and the blocks thereof, can be initially configured and subsequently reconfigured by the CPU 312. The CPU 312 can configure the FPUs 308 and the CLBs 320, using configuration instructions read the BRAM 324 and URAM 328. There may also be branching and looping in a program executing on the CPU 312 that controls the overall program flow, data flow and FPU or CLB reconfiguration. In one aspect, the cluster 304 can be configured as a FPGA utilizing its CLBs 320 and RAM 324 and 328. In another aspect, the cluster 304 can be configured as a very-long instruction word (VLIW) digital signal processor (DSP) utilizing its FPUs 308. The VLIW DSP can be utilized for convolutions in machine learning. The CPU 312 can configure the cluster 304 and customize the cluster 304 for a desired operation. Different clusters can be configured differently to perform different operations. In one aspect, the CPU 312 can dynamically configure the cluster 304 in real time or at run time. In another aspect, the CPU 312 may also configure the BRAM 324 and/or URAM 328. For example, the CPU 312 can configure a bit width of the BRAM 324 and/or URAM 328 (e.g. 1 bit 36K, 2 bit 18K, etc.).

As described above, the CPU 312 can be embedded with the other components of the cluster 304 and directly coupled to the components, such as the FPUs 308, using the local bus 336. The CPU 312 can be included in and can define the control plane, while the other components in the cluster can be included in and can define the data plane.

The CPU 312 can be a hard macro CPU inside the cluster 304, chip and routing fabric (132 in FIG. 1 or 232 in FIG. 2). The CPU 312 can be connected to the components (e.g. FPUs 308, CLBs 320, BRAM 324 and URAM 328) of the cluster 304. The CUPs 312 can form distributed hard macro CPUs inside the FPGA fabric. The cluster 304 can have its own internal bus 336. The CPU 312 can have hooks or direct communication connections to the components, such as FPUs 308, CLBs 320, etc.

The clusters 304 can have a software-like reprogramming ability that can maintain the semantics of branching through a program. The CPU 312 can provide a control plane to the data-path processing of the cluster 304.

Referring again to FIGS. 1 and 2, the CPU 112 or 212 of a first cluster 104 or 204 can reconfigure a second or subsequent cluster 104b or 204b, based on, for example, the data received by the first cluster 104 or 204. Again, the reconfiguration of the second cluster 104b or 204b can occur in real-time or at run-time. Thus, the second cluster 104b or 204b can configure itself (or the second CPU 112b or 212b can configure the second cluster 104b or 204b) based on a message or instructions received from the first cluster 104 or 204 (or the first CPU 112 or 212).

The reconfigurable clusters 104 and 204 can be arithmetic (FPUs 108 and 208) and memory intensive (RAM 124, 128, 224 and 228) in order to be able to implement local convolutional neural network (CNN) algorithms, or more traditional signal processing like FFT and linear algebra using complex numbers. The clusters 104 and 204 can be designed in such a way that the cluster configurations can be efficient in getting data progressing into the pipeline and therefore optimize routing resources that are typically both performance and resource limiting.

This overall approach can give the required compute density for compute intensive applications. While previously existing FPGAs are not very programmable compared to a CPU, the clusters 104 and 204 have the small RISC-V CPUs 112 and 212, for example. Unlike commercially available FPGA silicon on chip (SoC) devices, these CPUs 112 and 212 are tightly coupled to the fabric 132 and 232 and are widely distributed. The CPU 112 and 212 can act as the control plane and implement the data plane using software configurable hooks to the data plane. This architecture 100, 200 and 300 can provide a distributed control plane and a distributed data path(s). The data path(s) can benefit from the customization, while scheduling, looping, branching, and/or general control of the data path can be controlled by the distributed CPUs 112 and 212 of the clusters 104 and 204.

The CPUs 112 and 212 can be tightly coupled to the fabric 132 and 232 so that they can use a portion of the resources from the fabric 132 and 232 to customize their operations. For example, a single cluster 104 and 204 can use the CPU 112 and 212 and all the FPUs 108 and 208 to implement a VLIW DSP. Another cluster 104b and 204b can use the CPU 112b and 212b as loop manager and use FPGA, RAM and CLB 120 and 220 to implement a convolution for a machine learning process. In both cases above, the control plane can be switched from one operation to another as regular branching.

This architecture 100, 200 and 300 described herein can be used to map algorithms onto a mix of memory, FPU hardware and CPUs 112, 212 and 312. In one aspect, a library of streaming program blocks which can be connected in a computation graph using the architecture interconnect. This approach can mirror the GNU radio processing model. This architecture can be flexible to support evolving algorithms and workloads, instead of locking in a specialized processing array.

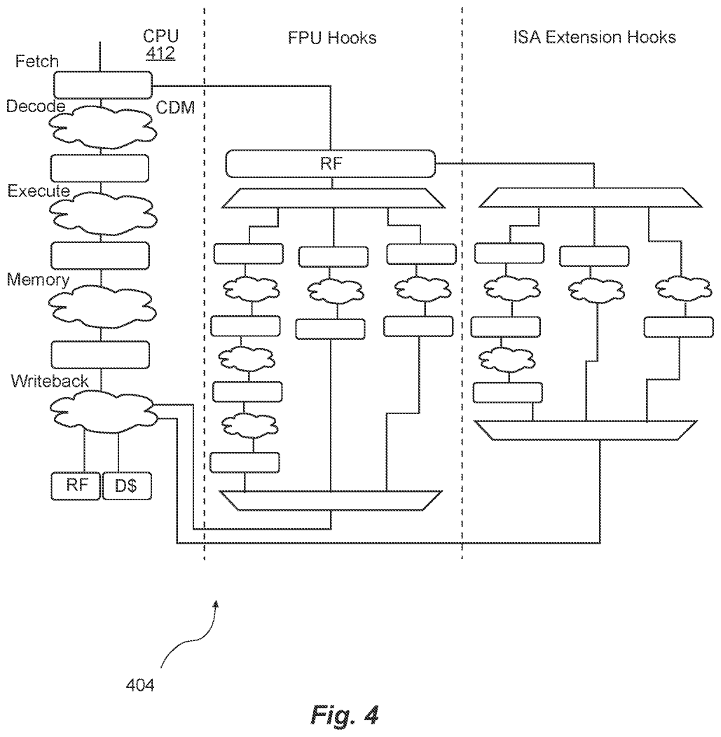

FIG. 4 illustrates an example of a high-level micro-architecture concept of the cluster 404 with a hard-macro CPU 412 with direct hooks or direct communication connections to other blocks in the cluster 404 to customize the cluster 404. The cluster 404 can perform multiple low-level functions in the context of real time signal processing and decision making. For example, the neighboring clusters can be dynamically reconfigured based on information extracted from the signal or from an out-of-band policy. Fast reconfiguration can be supported using local RAM as the configuration storage. Using a 1600 MHz configuration clock and length 80 configuration chains, the cluster 404 can be partially reconfigured in <50 ns. The CPU 414 can also be used to implement iterators and sequencers under program control. Reduced instruction set computer (RISC) instruction set architecture (ISA) extensions, e.g. RISC-V ISA, can also be used to implement general purpose acceleration instructions using the data path. RISC-V is an open-source ISA and leverages a diverse ecosystem of developers, which makes it suitable for customization. The ISA extensions can be implemented in the CLBs or FPUs.

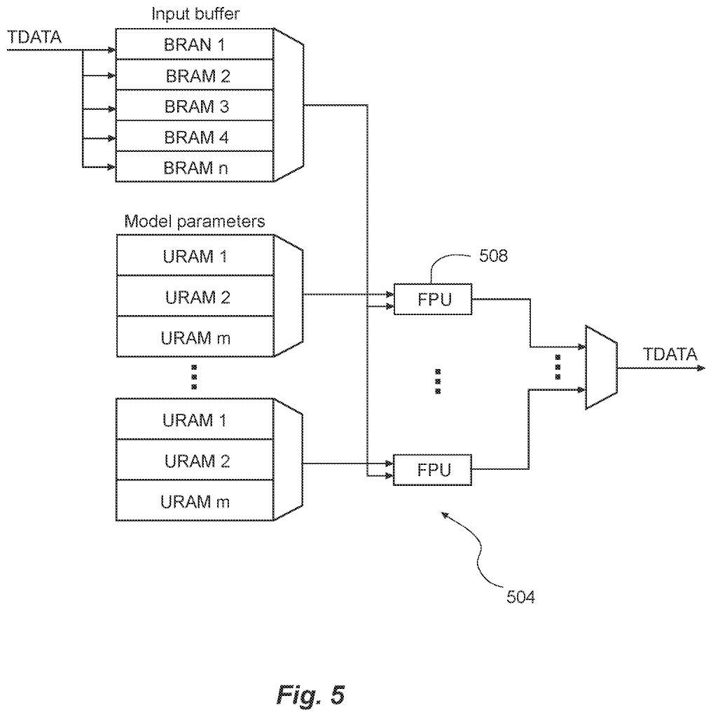

FIG. 5 illustrates a streaming dot-product operation implemented in the cluster 504. This architecture can be a flexible platform for implementing massively parallel flowgraph algorithms. The cluster 504 can be programmed using register transfer level (RTL) code and can be capable of both single instruction multiple data (SIMD) and pipelined parallelism. The RISC-V cluster(s) 504 can provide distributed control supported by an open-source tool chain. Finally, the DS-FPGA routing fabric (132 in FIG. 1 or 232 in FIG. 2) can allow the clusters 504 to be connected in arbitrary topologies to optimize the algorithms being implemented. FIG. 5 shows how the cluster 504 can be configured to perform a streaming dot product computation using parallel and pipelined FPUs 508. This enables deep model evaluation on streaming data at high speed.

Example parameters of the architecture described herein are summarized in Table 1.

TABLE 1
example parameters

| | |
|---|---|
| Technology | 16 nm |
| Core clock rate | 800 MHz |
| I/O density | 840 Gb/s full duplex (30 lanes @28 Gb/s serdes) |
| Compute density | 200 GLOP/mm2 at 25% utilization (1 FP16/1000 |
| | um, @800 MHz) |
| Software | Interrupt and Branching performance <20 ns |
| reconfiguration time | |
| Hardware | 50 ns (80 configuration bits @1.6 Ghz configuration |
| reconfiguration time | clock rate) |

FIG. 6 illustrates an example of a programmable routing fabric 632 with connection blocks 660 communicatively connected to the clusters 604 and to routing channels 666 between the plurality of clusters 604. The connection blocks 660 can be configured to define connections to the clusters 604 and the CLBs thereof. In addition, the programmable routing fabric 632 can have switching blocks 672 communicatively connected to the connection blocks 660. The switching blocks can 672 be configured to define connections between the routing channels 666.

Furthermore, the described features, structures, or characteristics may be combined in any suitable manner in one or more examples. In the preceding description, numerous specific details were provided, such as examples of various configurations to provide a thorough understanding of examples of the described technology. One skilled in the relevant art will recognize, however, that the technology can be practiced without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements can be devised without departing from the spirit and scope of the described technology.

What is claimed is:

1. A programmable compute architecture, comprising:
a plurality of floating point units (FPUs);
a random-access-memory (RAM) communicatively coupled to the FPUS;
a plurality of configurable logic blocks (CLBs) communicatively coupled to the RAM and the FPUs; and
a limited instruction set central processing unit (CPU) in a cluster with and communicatively coupled to the FPUs, the RAM, and the CLBs; and
wherein the limited instruction set CPU is capable of configuring the FPUs and the CLBs to control looping or branching for program segments executed by the FPUs and the CLBs.

2. The programmable compute architecture in accordance with claim 1, further comprising:
the FPUs, the RAM, and the CLBs defining a data plane;
the limited instruction set CPU defining a control plane; and
the limited instruction set CPU having a direct data connection to the data plane via a local bus in the cluster to configure the FPUs and the CLBs.

3. The programmable compute architecture in accordance with claim 1, wherein the cluster is configured to be dynamically reconfigured based on information extracted from an input signal using the RAM as configuration instruction storage.

4. The programmable compute architecture in accordance with claim 1, wherein the limited instruction set CPU is communicatively coupled to interconnects configured to route signals to and from the FPUs, the RAM, and the CLBs.

5. The programmable compute architecture in accordance with claim 1, further comprising:
an input router configured to route data to the cluster; and
an output router configured to route data from the cluster to other clusters.

6. The programmable compute architecture in accordance with claim 1, further comprising:
a local bus in the cluster; and
the limited instruction set CPU, the FPUs, the RAM, and the CLBs being communicatively coupled to the local bus.

7. The programmable compute architecture in accordance with claim 1, further comprising:
the limited instruction set CPU being formed on an integrated circuit (IC) with the FPUs, the RAM, and the CLBs.

8. A programmable compute architecture, comprising:
a plurality of floating point units (FPUs);
a random-access-memory (RAM) communicatively coupled to the FPUs;
a plurality of configurable logic blocks (CLBs) communicatively coupled to the RAM and the FPUs;
a local bus communicatively coupled to the FPUs, the RAM, and the CLBs; and
a limited instruction set central processing unit (CPU) in a cluster with and communicatively coupled to the FPUs, the RAM, and the CLBs to enable communication on the local bus.

9. The programmable compute architecture in accordance with claim 8, further comprising:
the limited instruction set CPU being embedded on an integrated circuit (IC) with the FPUs, the RAM, and the CLBs.

10. The programmable compute architecture in accordance with claim 8, further comprising:
the limited instruction set CPU being configured to configure the FPUs and the CLBs to control looping or branching of the FPUs and the CLBs.

11. The programmable compute architecture in accordance with claim 8, further comprising:
the FPUs, the RAM, and the CLBs defining a data plane;
the limited instruction set CPU defining a control plane; and
the limited instruction set CPU having a direct data connection to the data plane via the local bus in the cluster to configure the FPUs and the CLBs.

12. The programmable compute architecture in accordance with claim 8, wherein the cluster is configured to be dynamically reconfigured based on information extracted from an input signal using the RAM as configuration instruction storage.

13. The programmable compute architecture in accordance with claim 8, wherein the limited instruction set CPU is communicatively coupled to interconnects configured to route signals to and from the FPUs, the RAM, and the CLBs.

14. The programmable compute architecture in accordance with claim 8, further comprising:
an input router configured to route data to the cluster; and
an output router configured to route data from the cluster to other clusters.

15. A programmable compute architecture, comprising:
a plurality of streaming clusters communicatively coupled to one another;
a cluster from the plurality of streaming clusters comprising blocks that are communicatively coupled, including:
a plurality of floating point units (FPUs);
block random-access-memory (BRAM) communicatively coupled to the FPUs and configured to act as input buffer storage to the FPUs;
unified random-access-memory (URAM) communicatively coupled to the FPUs and configured to store parameters used by the FPUs;
a plurality of configurable logic blocks (CLBs) communicatively coupled to the BRAM and the FPUs and having logic elements configured to perform operations;
a local bus communicatively coupled to the FPUs, the BRAM, the URAM, and the CLBs;
a limited instruction set central processing unit (CPU) in a cluster with and communicatively coupled to the FPUs, the BRAM, the URAM, and the CLBs to enable communication on the local bus;
the limited instruction set CPU being configured to configure the FPUs and the CLBs to control looping or branching of the FPUs and the CLBs; and
the CPU being configured to communicate with another limited instruction set CPU of another cluster.

16. The programmable compute architecture in accordance with claim 15, each cluster further comprising:
the FPUs, the BRAM, the URAM, and the CLBs defining a data plane;
the limited instruction set CPU defining a control plane; and
the limited instruction set CPU having a direct data connection to the data plane via the local bus in the cluster to configure the FPUs and the CLBs.

17. The programmable compute architecture in accordance with claim 15, wherein the cluster is configured to be dynamically reconfigured based on information extracted from an input signal using the BRAM as configuration instruction storage.

18. The programmable compute architecture in accordance with claim 15, each cluster further comprising:
an input router configured to route data to the cluster; and
an output router configured to route data from the cluster to other clusters.

19. The programmable compute architecture in accordance with claim 15, further comprising:
each CPU being embedded on an integrated circuit (IC) with the FPUs, the BRAM, the URAM and the CLBs.

20. The programmable compute architecture in accordance with claim 15, wherein:
a first cluster with a first CPU are configured to perform a first operation; and
a second cluster with a second CPU are configured to perform a different second operation.

21. The programmable compute architecture in accordance with claim 15, further comprising:
connection blocks communicatively coupled to routing channels between the plurality of clusters, wherein the connection blocks are configured to define connections to the clusters;
switching blocks communicatively coupled to the connection blocks and configured to define connections between the routing channels;
the plurality of streaming clusters communicatively coupled to one another by the connection blocks and the switching blocks define a programmable fabric; and
the plurality of streaming clusters providing an array of limited instruction set CPUs distributed across the programmable fabric.

22. The programmable compute architecture in accordance with claim 15, wherein the cluster is configured to be reconfigured from a first operation to a different second operation by the limited instruction set CPU.
